(19) United States
(12) Patent Application Publication
(10) Pub. No.: US 2024/0125158 A1
(43) Pub. Date: Apr. 18, 2024

(54) APPLIANCE DOOR HINGES WITH ELECTRICAL CONDUCTOR PATH

(71) Applicants: BSH Home Appliances Corporation, Irvine, CA (US); BSH Hausgeräte GmbH, Munich (DE)

(72) Inventor: Steven Langenscheidt, Arapahoe, NC (US)

(21) Appl. No.: 17/965,833

(22) Filed: Oct. 14, 2022

(51) Int. Cl. E05D 11/00; E05D 3/02; F24C 15/02

(52) U.S. Cl. CPC E05D 11/0081; E05D 3/022; F24C 15/023

(57) ABSTRACT

A domestic appliance includes: a main body; a chamber in the main body; a door to the chamber, the door being movable between an open position and a closed position; an electrical device on the door; a hinge connected to the main body and having a hinge arm; an electrical conductor pad on the hinge arm; a hinge arm receiver mounted to the door and configured to removably receive the hinge arm; and an electrical contact on the hinge arm receiver that is electrically connected to the electrical device, the electrical contact making an electrical connection with the conductor pad when the door is in an installed position on the hinge arm.

### FIELD OF THE INVENTION

The invention is directed to a domestic appliance with door hinges that have electrical contacts. More particularly, embodiments of the invention are directed to a domestic appliance that has a door with power and data connections, and has hinges that allow removal of the door without disconnecting wires.

An example of an application for the invention is a cooking appliance with a door that has a data input and/or display.

### BACKGROUND OF THE INVENTION

Some kitchens include a cooking appliance such as an oven. In some cases, the cooking appliance has controls and/or a display on the door of the appliance. In such appliances, power and data transmission between the body of the appliance and the door is needed. In some cases, this transmission is through a wire or wiring harness between the appliance body and the door.

Applicants recognized an improvement to the above arrangement and implement that improvement in embodiments of the invention.

### SUMMARY

Some domestic appliances have doors that open to a cooking or other chamber that allow access to the chamber. Some of these appliances have lights, controls, and/or indicators on the door that require electrical connections to a housing or main body of the appliance. These electrical connections can be made by way of wires that electrically connect the door to the main body.

In some appliances, it is beneficial to be able to remove or separate the door from the main body of the appliance to facilitate cleaning, maintenance, service, or other actions. Appliances that electrically connect the door to the main body by way of electrical wires have the disadvantage that the wires have to be disconnected from the door, the main body, or both to allow the door to be removed from the main body. Also, some appliances are shipped with the door separated from the main body of the appliance and the door must be mounted to the main body (and the wires connected) at the installation site. Disconnecting and/or connecting these wires can be difficult for a non-trained user of the appliance such as, for example, a home owner.

The invention achieves the benefit of eliminating the need to connect or disconnect any wires between the door of an appliance and the main body of the appliance.

Particular embodiments of the invention are directed to a domestic appliance that includes: a main body; a chamber in the main body; a door to the chamber, the door being movable between an open position and a closed position; an electrical device on the door; a hinge connected to the main body and having a hinge arm; an electrical conductor pad on the hinge arm; a hinge arm receiver mounted to the door and configured to removably receive the hinge arm; and an electrical contact on the hinge arm receiver that is electrically connected to the electrical device, the electrical contact making an electrical connection with the conductor pad when the door is in an installed position on the hinge arm.

Other embodiments of the invention are directed to a door hinge assembly for a domestic appliance, the assembly including: a hinge body configured to connect to a main body of the appliance; a hinge arm pivotably connected to the hinge body; an electrical conductor pad on the hinge arm; a hinge arm receiver configured to be mounted to the door and configured to removably receive the hinge arm; and an electrical contact on the hinge arm receiver that is configured to be electrically connected to the door when the hinge arm receiver is mounted to the door, the electrical contact making an electrical connection with the conductor pad when the hinge arm receiver is in an installed position on the hinge arm.

Other embodiments of the invention are directed to a door and hinge assembly for a domestic appliance, the assembly including: a door; a hinge body configured to connect to a main body of the appliance; a hinge arm pivotably connected to the hinge body; an electrical conductor pad on the hinge arm; a hinge arm receiver mounted to the door and configured to removably receive the hinge arm; and an electrical contact on the hinge arm receiver that is electrically connected to the door, the electrical contact making an electrical connection with the conductor pad when the hinge arm receiver is in an installed position on the hinge arm.

### BRIEF DESCRIPTION OF THE DRAWINGS

The following figures form part of the present specification and are included to further demonstrate certain aspects of the disclosed features and functions and should not be used to limit or define the disclosed features and functions. Consequently, a more complete understanding of the exemplary embodiments and further features and advantages thereof may be acquired by referring to the following description taken in conjunction with the accompanying drawings, wherein:

FIG. 1 is a perspective view of an exemplary appliance in accordance with embodiments of the invention;

FIG. 2 is a perspective view of an exemplary hinge mechanism in accordance with embodiments of the invention;

FIG. 3 is a sectional view of the hinge mechanism shown in FIG. 2 in a closed door position;

FIG. 4 is a sectional view of the hinge mechanism shown in FIG. 2 in an open door position;

FIG. 5 is a partial sectional view of the hinge mechanism shown in FIG. 2 in an open door position;

FIG. 6 is a partial sectional view of the hinge mechanism shown in FIG. 2 in a closed door position;

FIG. 7 is a perspective schematic view of an exemplary hinge arm receiver in accordance with embodiments of the invention;

FIG. 8 is sectional view along section line VIII-VIII in FIG. 7; and

FIG. 9 is a schematic view of an exemplary contact in accordance with embodiments of the invention.

### DETAILED DESCRIPTION

The invention is described herein with reference to the accompanying drawings in which exemplary embodiments of the invention are shown. The invention may, however, be embodied in many different forms and should not be construed as limited to the embodiments set forth herein.

As explained above, embodiments of the invention provide an improvement to an appliance that has a door that includes lights, controls, and/or displays that require electrical connection to a main body of the appliance.

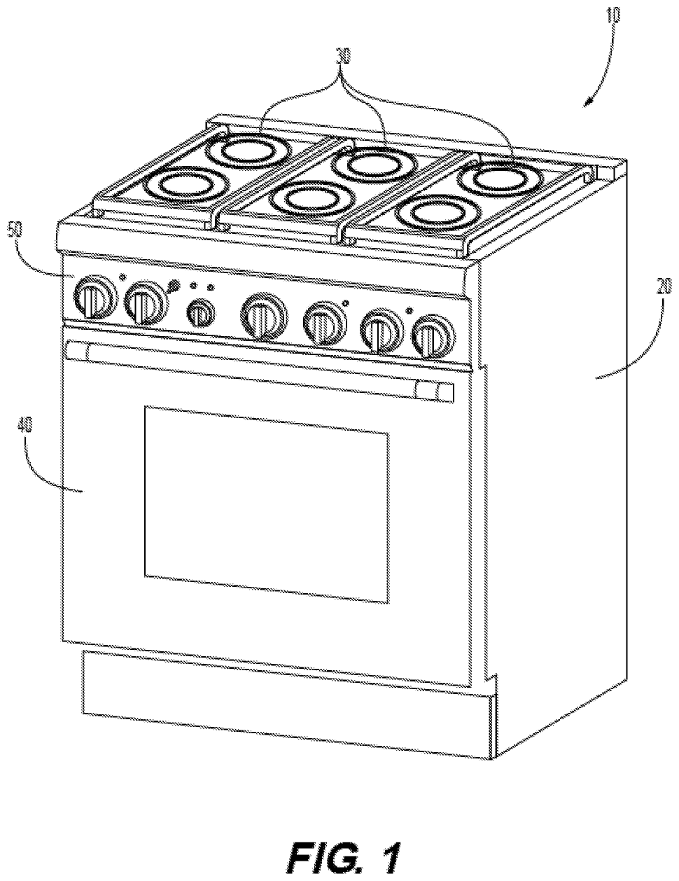

FIG. 1 shows a domestic appliance 10 which is, in this example, a cooking appliance. Applicant 10 has a housing 20 that includes a cooking chamber. In this example, appliance 10 has six heating elements 30 located on its upper area. A door 40 is movable between an open position in which access is available to the cooking chamber, and a closed position (shown in FIG. 1) in which the cooking chamber is closed. A control panel 50 includes a number of controls that can be manipulated by a user to control various functions of appliance 10. Appliance 10 also includes a controller (not shown) that, in this example, is positioned behind a front surface of control panel 50. The controller is, for example, an electronic controller that receives input from the controls of control panel 50, controls located on door 40, sensors located at various positions in appliance 10, and other inputs. The controller also provides output that is sent to, for example, heating elements 30, one or more heating elements in the cooking chamber, lights (including on door 40), displays (including on door 40), and other devices.

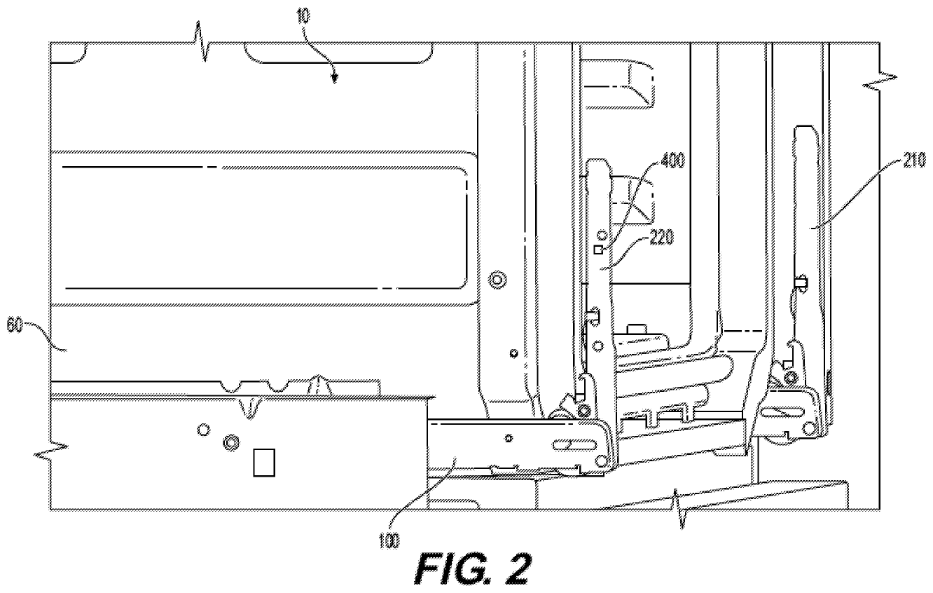

Door 40 pivots between the closed position shown in FIG. 1, a fully open position, and a plurality of positions between the closed position and the fully open position. This pivoting is provided by a hinge mechanism such as, for example, the hinge mechanism shown in FIGS. 2-6.

FIG. 2 shows a hinge body 100 pivotably connected to a hinge arm 220. In this example, appliance 10 has two hinge assemblies, one of which includes hinge arm 220 and the other of which includes a hinge arm 210. Embodiments of the invention will be discussed with reference to hinge body 100 and hinge arm 220. It is noted that such description also applies to the hinge assembly that includes hinge arm 210. In this example, hinge body 100 is attached to a main body 60 of appliance 10.

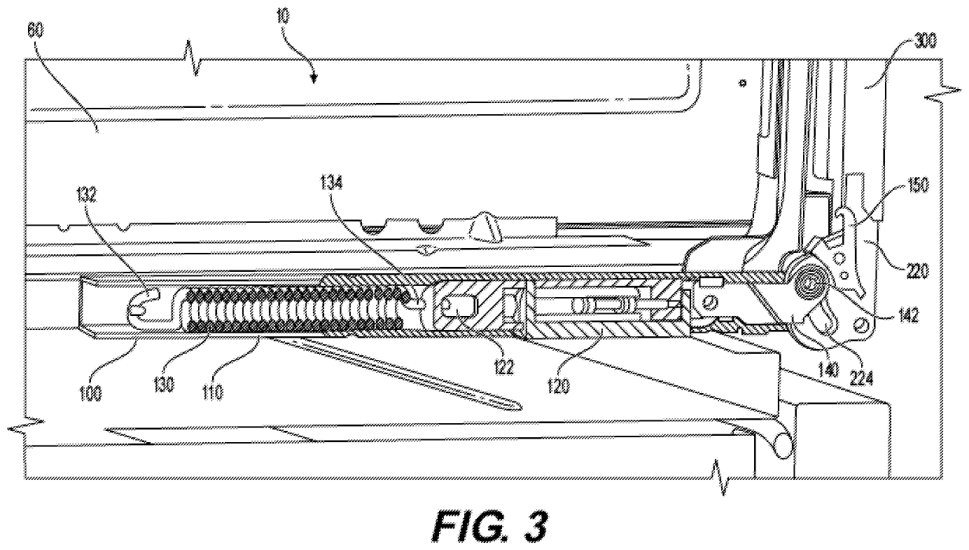

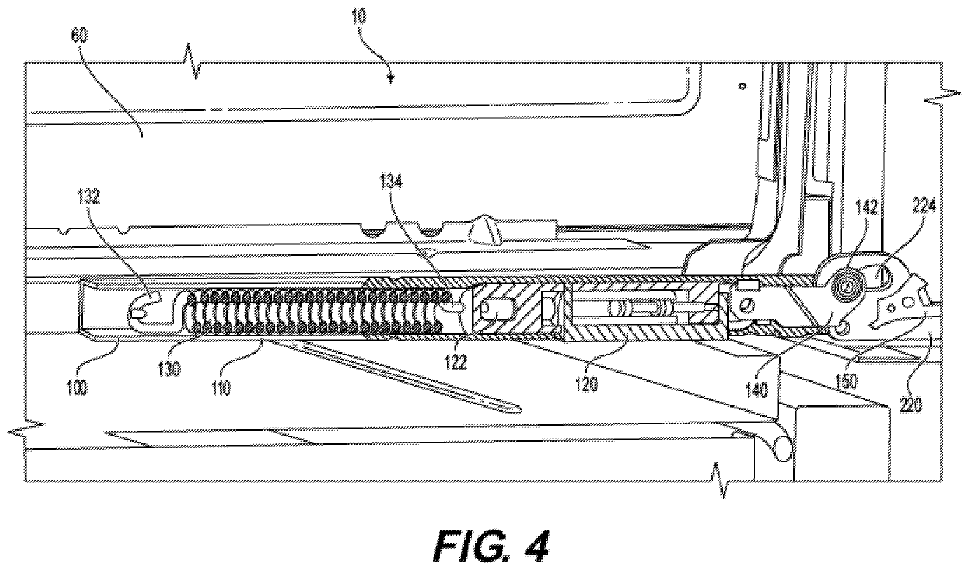

FIG. 3 shows hinge body 100 with hinge arm 220 in a closed or fully retracted position that corresponds to door 40 being in the closed position. FIG. 4 shows hinge body 100 with hinge arm 220 in a fully open position that corresponds to door 40 being in the fully open position. Hinge body 100 has a main body 110 in which a slide member 120 can slide. Slide member 120 is attached at one end to a pin bracket 140. Pin bracket 140 holds a pivot pin 142 that engages hinge arm 220. Hinge arm 220 has a curved slot 224 which receives pivot pin 142 and controls the movement of pivot pin 142 when hinge arm 220 is moved from the fully retracted position (as shown in FIG. 3) to the fully open position (shown in FIG. 4). A spring 130 has a hook 132 at one end that is attached to a hook on main body 110 and has a hook 134 at its other end that is attached to an opening 122 in slide member 120. A door engagement bracket 150 provides a mechanical connection to door 40 to prevent door 40 from being unintentionally disengaged from hinge arm 220. As shown in FIG. 3, spring 130 is in a contracted position when hinge arm 220 is in the fully retracted position. As shown in FIG. 4, spring 130 is in an expanded position when hinge arm 220 is in the fully open position. In the position shown in FIG. 4, spring 130 is expanded by slide member 120 being pulled toward the front of appliance 10 by curved slot 224 pulling pivot pin 142 toward the front of appliance 10. This expansion of spring 130 exerts force on door 40 to maintain a closing force on door 40 in a first portion of the arc through which door 40 swings as it is being opened.

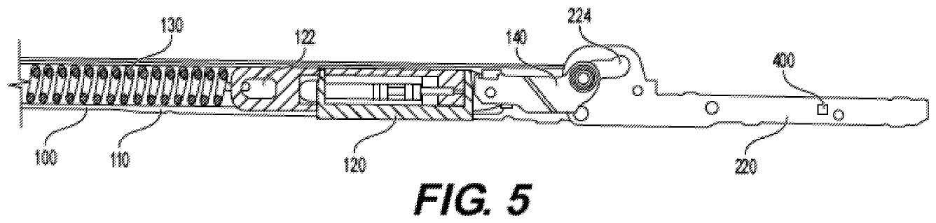

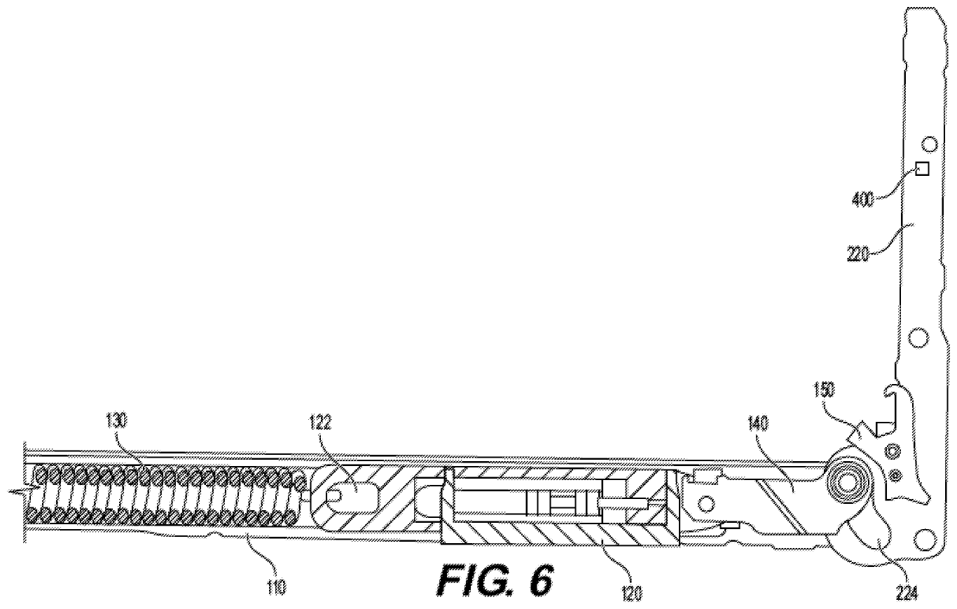

FIG. 6 shows hinge body 100 and hinge arm 220 removed from appliance 10 with hinge arm 220 in the closed or fully retracted position that corresponds to door 40 being in the closed position. FIG. 5 shows hinge body 100 and hinge arm 200 removed from appliance 10 with hinge arm 220 in the fully open position. In embodiments, an electrical conductor pad 400 is mounted on hinge arm 220 and is connected by, for example, wires (not shown) to the controller in appliance 10. Conductor pad 400 is configured to align with, and contact, a corresponding electrical contact on door 40 to provide a power and/or a signal connection between door 40 and the controller (or other device) of appliance 10. In embodiments, one or more conductor pads 400 are provided on one or both of hinge arm 220 and hinge arm 210. In embodiments, separate conductor pads 400 are provided for power and for signal.

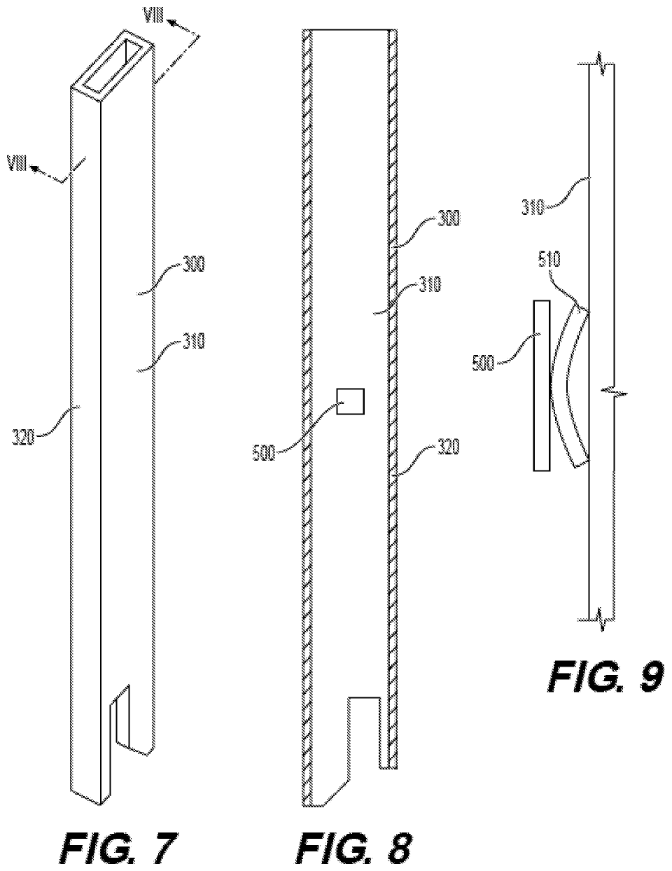

FIGS. 7 and 8 show a hinge arm receiver 300 that is attached to door 400 and configured to receive hinge arm 220. In embodiments, hinge arm receiver 300 is glued, welded, screwed, or otherwise fixed to door 40. In this example, hinge arm receiver 300 has walls 310, 320 that form a tubular profile that is configured to receive hinge arm 220 in a snug fitting arrangement that limits movement of hinge arm 220 to movement along a longitudinal axis of hinge arm receiver 300. This snug fitting arrangement prevents door 40 from moving relative to hinge arm 220 (other than in the direction along the longitudinal axis of hinge arm receiver 300).

As shown in FIG. 8, hinge arm receiver 300 has an electrical contact 500 mounted to an inside surface of wall 310. Electrical contact 500 is mounted in a location that causes it to align with conductor pad 400 on hinge arm 220 when door 40 is in an installed position on appliance 10 (as shown in FIG. 1). FIG. 9 shows an example of a mechanism to ensure proper electrical connection between electrical contact 500 and conductor pad 400. In this example, a spring 510 between electrical contact 500 and wall 310 exerts force to urge electrical contact 500 away from wall 310. This force presses electrical contact 500 into contact with conductor pad 400 to provide a secure electrical connection between electrical contact 500 and conductor pad 400. Other embodiments use other forms of springs or urging devices to press electrical contact 500 and conductor pad 400 together.

Embodiments include a sensor that determines the position of door 40 relative to housing 20. The sensor sends a signal to the controller when door 40 is in an open position so that, in embodiments, the controller stops power and/or signal transmission to door 40 when door 40 is in an open position. In embodiments, the sensor is located on door engagement bracket 150, hinge arm 220, slide member 120, pin bracket 140, or some other part that moves (or has an adjacent part move) when door 40 is opened.

In use, embodiments of the invention operate as follows. When door 40 is opened, the sensor senses the opening of door 40 and sends a signal to the controller to stop power and signal being transmitted to door 40. A user then disengages door engagement bracket(s) 150 and pulls door 40 upward to slide hinge arm receiver(s) 300 off of hinge arms 220, 210. As a result of hinge arm receiver(s) 300 moving relative to hinge arms 220, 210, electrical contact(s) 500 move out of alignment with conductor pad(s) 400 and the electrical connection between hinge arms 220, 210 and hinge arm receiver(s) 300 is broken. As a result, door 40 is not longer connected to power and can be safely removed by the user or technician. The door can then be cleaned and/or serviced without any risk of the user or technician coming into contact with electrical power from appliance 10.

It will be appreciated that variants of the above-disclosed and other features and functions, or alternatives thereof, may be combined into many other different systems or applications. Any of the features described above can be combined with any other feature described above as long as the combined features are not mutually exclusive. Various presently unforeseen or unanticipated alternatives, modifications, variations or improvements therein may be subsequently made by those skilled in the art which are also intended to be encompassed by the invention.

What is claimed is:

1. A domestic appliance, comprising:
a main body;
a chamber in the main body;
a door to the chamber, the door being movable between an open position and a closed position;
an electrical device on the door;
a hinge connected to the main body and having a hinge arm;
an electrical conductor pad on the hinge arm;
a hinge arm receiver mounted to the door and configured to removably receive the hinge arm; and
an electrical contact on the hinge arm receiver that is electrically connected to the electrical device, the electrical contact making an electrical connection with the conductor pad when the door is in an installed position on the hinge arm.

2. The appliance of claim 1, wherein the chamber is a cooking chamber.

3. The appliance of claim 1, wherein the conductor pad on the hinge arm comprises a plurality of electrical conductor pads, each of the conductor pads is configured to make the electrical connection with the electrical contact.

4. The appliance of claim 1, wherein the hinge arm receiver has an inside surface,
the electrical contact is mounted to the inside surface of the hinge arm receiver, and
the electrical contact comprises a spring that urges the electrical contact away from the inside surface.

5. The appliance of claim 4, wherein the spring urges the electrical contact toward the conductor pad when the door is in the installed position on the hinge such that the electrical contact touches the conductor pad and makes the electrical connection.

6. The appliance of claim 1, further comprising an opening sensor that senses that the door is in a position other than the closed position,
wherein the opening sensor sends a signal to a controller to interrupt a power supply to the door as a result of the door being in the position other than the closed position.

7. The appliance of claim 1, wherein the hinge comprises a pivot pin around which the hinge arm pivots relative to the main body.

8. The appliance of claim 7, wherein the hinge arm further comprises a curved slot, and
the pivot pin travels in the curved slot when the door moves between the open position and the closed position.

9. A door hinge assembly for a domestic appliance, the assembly comprising:
a hinge body configured to connect to a main body of the appliance;
a hinge arm pivotably connected to the hinge body;
an electrical conductor pad on the hinge arm;
a hinge arm receiver configured to be mounted to the door and configured to removably receive the hinge arm; and
an electrical contact on the hinge arm receiver that is configured to be electrically connected to the door when the hinge arm receiver is mounted to the door, the electrical contact making an electrical connection with the conductor pad when the hinge arm receiver is in an installed position on the hinge arm.

10. The assembly of claim 9, wherein the conductor pad on the hinge arm comprises a plurality of electrical conductor pads, each of the conductor pads is configured to make the electrical connection with the electrical contact.

11. The assembly of claim 9, wherein the hinge arm receiver has an inside surface,
the electrical contact is mounted to the inside surface of the hinge arm receiver, and
the electrical contact comprises a spring that urges the electrical contact away from the inside surface.

12. The assembly of claim 11, wherein the spring urges the electrical contact toward the conductor pad when the hinge arm receiver is in an installed position on the hinge arm such that the electrical contact touches the conductor pad.

13. The assembly of claim 9, further comprising an opening sensor that senses that the hinge arm is in a position relative to the hinge body other than a fully retracted position.

14. The assembly of claim 9, wherein the hinge comprises a pivot pin around which the hinge arm pivots relative to the hinge body.

15. The assembly of claim 14, wherein the hinge arm further comprises a curved slot, and
the pivot pin travels in the curved slot when the hinge arm moves between a fully retracted position and a position other than the fully retracted position.

16. A door and hinge assembly for a domestic appliance, the assembly comprising:
a door;
a hinge body configured to connect to a main body of the appliance;
a hinge arm pivotably connected to the hinge body;
an electrical conductor pad on the hinge arm;
a hinge arm receiver mounted to the door and configured to removably receive the hinge arm; and
an electrical contact on the hinge arm receiver that is electrically connected to the door, the electrical contact making an electrical connection with the conductor pad when the hinge arm receiver is in an installed position on the hinge arm.

17. The assembly of claim 16, wherein the conductor pad on the hinge arm comprises a plurality of electrical conductor pads, each of the conductor pads is configured to make the electrical connection with the electrical contact.

18. The assembly of claim 16, wherein the hinge arm receiver has an inside surface,
the electrical contact is mounted to the inside surface of the hinge arm receiver,
the electrical contact comprises a spring that urges the electrical contact away from the inside surface, and
the spring urges the electrical contact toward the conductor pad when the hinge arm receiver is in the installed position on the hinge arm such that the electrical contact touches the conductor pad.

19. The assembly of claim 16, further comprising an opening sensor that senses that the hinge arm is in a position relative to the hinge body other than a fully retracted position.

20. The assembly of claim 16, wherein the hinge comprises a pivot pin around which the hinge arm pivots relative to the hinge body,
the hinge arm further comprises a curved slot, and
the pivot pin travels in the curved slot when the hinge arm moves between a fully retracted position and a position other than the fully retracted position.
